(19) United States
(12) Patent Application Publication
(10) Pub. No.: US 2020/0090586 A1
(43) Pub. Date: Mar. 19, 2020

(54) PIXEL CIRCUIT AND DRIVING METHOD THEREOF, ARRAY SUBSTRATE AND DISPLAY DEVICE

(71) Applicant: BOE TECHNOLOGY GROUP CO., LTD.

(72) Inventors: Xiaolong HE, Beijing (CN); Zhifu LI, Beijing (CN); Zhiyuan JI, Beijing (CN); Jikai YAO, Beijing (CN)

(73) Assignees: BOE TECHNOLOGY GROUP CO., LTD., Beijing (CN); BOE TECHNOLOGY GROUP CO., LTD., Beijing (CN)

(21) Appl. No.: 15/750,816

(22) PCT Filed: Aug. 10, 2017
(86) PCT No.: PCT/CN2017/096797

§ 371 Date: Feb. 6, 2018

(30) Foreign Application Priority Data
Aug. 19, 2016 (CN) 201610695975.X

(51) Int. Cl. G09G 3/3233; G09G 3/3266; G09G 3/3275

(52) U.S. Cl. CPC G09G 3/3233; G09G 3/3275; G09G 3/3266

(57) ABSTRACT

The present disclosure provides a pixel circuit and a driving method thereof, a corresponding array substrate and display device. The pixel circuit comprises: an inorganic electroluminescent device, a scan terminal, a data write terminal, a first level input terminal, a second level input terminal, a gating circuit, a drive circuit, and an energy storage circuit.

### CROSS REFERENCE TO RELATED APPLICATIONS

The present application is the U.S. national phase entry of PCT/CN2017/096797, with an international filling date of Aug. 10, 2017, which claims the priority of the Chinese patent application No. 201610695975.X filed on Aug. 19, 2016, the entire disclosures of which is-are incorporated herein by reference.

### TECHNICAL FIELD

The present disclosure relates to the field of display technologies, and in particular to a pixel circuit and a driving method thereof, a corresponding array substrate and display device.

### BACKGROUND ART

As compared with organic light emitting diode (OLED) display products, inorganic light emitting diode (ILED) display products have many advantages, such as high transparency (with a transmittance greater than 80%), flexibility, high color gamut, high reliability, long lifetime, low power consumption, mold-opening free, heteromorphosis, and repairable.

At present, an ILED display product is mainly driven passively to achieve display. That is, the ILED is connected with a gate line at one end, and with a data line at the other end. When the gate line provides a scan signal and the data line provides a data signal, a voltage is generated over the two ends of the ILED, so that the ILED starts to emit light. However, since gate lines are generally scanned line by line, when the n^{th} gate line is scanned, the (n−1)^{th} gate line will have no scan signal thereon. Therefore, only one row of display units emit light at each instant of time, which results in a lower overall brightness of the display image and a poorer display effect. As the display product increases in size, the display effect will deteriorate.

### SUMMARY

The present disclosure aims to solve one of the technical problems existing in current solutions, and specifically, proposes a pixel circuit and a driving method thereof, a corresponding array substrate and display device, so as to improve the display effect of inorganic electroluminescent (EL) display products.

To this end, the present disclosure provides a pixel circuit, comprising: an inorganic EL device, a scan terminal, a data write terminal, a first level input terminal, a second level input terminal, a gating circuit, a drive circuit, and an energy storage circuit. Specifically, a control terminal of the gating circuit is connected with the scan terminal, an input terminal thereof is connected with the data write terminal, and an output terminal thereof is connected with a control terminal of the drive circuit, wherein the gating circuit is configured to be switched on when an ON signal is inputted into the scan terminal and switched off when an OFF signal is inputted into the scan terminal Besides, an input terminal of the drive circuit is connected with the first level input terminal, and an output terminal thereof is connected with a first pole of the inorganic EL device, wherein the drive circuit is configured to provide a corresponding drive current to the inorganic EL device according to a data signal received at the control terminal thereof Furthermore, a second pole of the inorganic EL device is connected with the second level input terminal Additionally, a first terminal of the energy storage circuit is connected with the first level input terminal, and a second terminal thereof is connected with the control terminal of the drive circuit, wherein the energy storage circuit is configured to store energy when the ON signal is inputted into the scan terminal and release the stored energy when the OFF signal is inputted into the scan terminal

Optionally, the gating circuit comprises a gating transistor, wherein a gate of the gating transistor is the control terminal of the gating circuit, a first pole thereof is the input terminal of the gating circuit, and a second pole thereof is the output terminal of the gating circuit.

Optionally, the gating transistor is an N-type thin film transistor, and the ON signal is a high level signal.

Optionally, the drive circuit comprises a drive transistor, wherein a gate of the drive transistor is the control terminal of the drive circuit, a first pole thereof is the input terminal of the drive circuit, and a second pole thereof is the output terminal of the drive circuit.

Optionally, the drive transistor is an N-type thin film transistor.

Optionally, the energy storage circuit comprises a capacitor, wherein a first terminal of the capacitor is the first terminal of the energy storage circuit, and a second terminal thereof is the second terminal of the energy storage circuit.

Optionally, the first level input terminal is a high level input terminal, and the second level input terminal is a low level input terminal.

Correspondingly, the present disclosure further provides a driving method for the above pixel circuit. The driving method comprises: in a gating stage, providing an ON signal to the scan terminal of the pixel circuit and providing a data signal to the data write terminal, such that the gating circuit is switched on, wherein the data signal is written into the control terminal of the drive circuit, the drive circuit provides a corresponding drive current to the inorganic EL device according to the data signal, and the energy storage circuit stores energy; and in a non-gating stage following the gating stage, providing an OFF signal to the scan terminal of the pixel circuit, such that the gating circuit is switched off, wherein the energy storage circuit continues to provide a corresponding drive current to the inorganic EL device by releasing the stored energy.

Correspondingly, the present disclosure further provides an array substrate. The array substrate comprises a plurality of gate lines and a plurality of data lines, wherein the plurality of gate lines and the plurality of data lines divide the array substrate into a plurality of pixel units. Specifically, each pixel unit is provided with the pixel circuit as proposed in the present disclosure, wherein the scan terminal of the pixel circuit is connected with a corresponding gate line, and the data write terminal of the pixel circuit is connected with a corresponding data line.

Correspondingly, the present disclosure further provides a display device, comprising the array substrate as proposed in the present disclosure.

In an embodiment of the present disclosure, when an ON signal is inputted into the scan terminal, the gating circuit is switched on and a data signal of the data input terminal is inputted into the control terminal of the drive circuit. Thereby, the drive circuit provides to the inorganic EL device a drive signal corresponding to the data signal, such that the inorganic EL device emits light with a corresponding brightness. Meanwhile, the energy storage circuit stores energy by means of a voltage input at the two ends thereof This stage can be regarded as a gating stage. When no ON signal is inputted into the scan terminal any longer, the input terminal of the gating circuit is disconnected from the output terminal thereof In this case, since the energy storage circuit has stored energy determined by the first level input terminal and the data write terminal, voltage at the control terminal of the drive circuit will remain the same as in the gating stage for a period of time. Therefore, the inorganic EL device can be continuously provided with a same drive current as that in the gating phase, such that light can be emitted continuously.

When a frame of image is displayed on a display device using the pixel circuit, the ON signal is generally provided to the scan terminal of the pixel circuit line by line. In this case, if the ON signal is provided to the scan terminal of the pixel circuit in the n^{th} row, the corresponding inorganic EL device will emit light. When the ON signal is inputted into the scan terminal of the pixel circuit after the n^{th} row, the inorganic EL device of the pixel circuit in the n^{th} row will continue to emit light, due to the presence of the energy storage circuit. Therefore, on the premise that advantages such as high color gamut, high transmittance, and long lifetime of the inorganic EL display device are ensured, the display effect of the inorganic EL display device can be further improved with higher entire brightness and more consecutive pictures. Besides, when the inorganic EL device is applied to a large-sized display device, a good display effect can also be achieved. Thus, the inorganic EL device can be applied more widely.

### BRIEF DESCRIPTION OF THE DRAWINGS

The drawings are used to provide further understanding of the present disclosure and constitute part of the specification. Besides, the drawings make explanations of the present disclosure together with the specific embodiments as follows, but do not limit the present disclosure in any sense. In the drawings:

FIG. 1 is a schematic structure view for each portions of the pixel circuit as proposed in an embodiment of the present disclosure;

FIG. 2 is a schematic structure view for a pixel circuit as proposed in an embodiment of the present disclosure;

FIG. 3 is a signal timing chart for a pixel circuit as proposed in an embodiment of the present disclosure;

FIG. 4 is a graph showing the relationship between the drive current provided to the inorganic EL device by the pixel circuit in FIG. 2 and the voltage at the data write terminal; and

FIG. 5 is a graph showing the relationship between the brightness of the inorganic EL device and the drive current in the pixel circuit of FIG. 2.

### DETAILED DESCRIPTION OF THE EMBODIMENTS

Specific embodiments of the present disclosure will be described in detail with reference to the drawings. It should be understood that the specific embodiments described herein are only used for illustrating and explaining the present disclosure, instead of limiting it.

In each drawing, components used in the present disclosure are indicated by the following reference signs: 10 inorganic EL device; 20 gating circuit; 30 drive circuit; 40 energy storage circuit; Vscan scan terminal; Vdata data write terminal; V1 first level input terminal; V2 second level input terminal; T1 gating transistor; T2 drive transistor; and Cs capacitor.

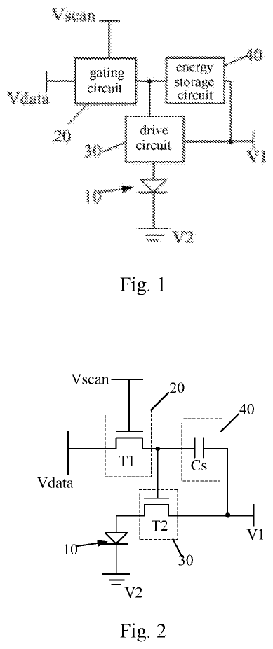

According to an aspect of the present disclosure, a pixel circuit is provided. As shown in FIG. 1, the pixel circuit comprises an inorganic EL device 10, a scan terminal Vscan, a data write terminal Vdata, a first level input terminal V1, a second level input terminal V2, a gating circuit 20, a drive circuit 30, and an energy storage circuit 40. A control terminal of the gating circuit 20 is connected with the scan terminal Vscan, an input terminal thereof is connected with the data write terminal Vdata, and an output terminal thereof is connected with a control terminal of the drive circuit 30, wherein the gating circuit 20 is configured to be switched on when an ON signal is inputted into the scan terminal Vscan and switched off when an OFF signal is inputted into the scan terminal Vscan. It can be understood that the gating circuit 20 being switched on means that there is a current passing between the input terminal and the output terminal thereof An input terminal of the drive circuit 30 is connected with the first level input terminal V1, and an output terminal thereof is connected with a first pole of the inorganic EL device 10, wherein the drive circuit 30 is configured to provide a corresponding drive current to the inorganic EL device 10 according to a data signal received at the control terminal thereof A second pole of the inorganic EL device 10 is connected with the second level input terminal V2. A first terminal of the energy storage circuit 40 is connected with the first level input terminal V1, and a second terminal thereof is connected with the control terminal of the drive circuit 30, wherein the energy storage circuit 40 is configured to store energy when the ON signal is inputted into the scan terminal Vscan and release the stored energy when the OFF signal is inputted into the scan terminal It should be understood that a first level signal is inputted into the first level input terminal V1 continuously, and a second level signal is inputted into the second level input terminal V2 continuously.

Typically, it is impossible for the inorganic EL device to emit light until the ON signal is inputted into the scan terminal According to an embodiment of the present disclosure, when the ON signal is inputted into the scan terminal Vscan, the gating circuit 20 is switched on, and the data signal at the data input terminal Vdata is inputted into the control terminal of the drive circuit 30. In this case, the drive circuit 30 provides to the inorganic EL device 10 a drive signal corresponding to the data signal, such that the inorganic EL device 10 emits light with a corresponding brightness. In the meantime, the storage circuit 40 stores energy by means of a voltage over the two ends thereof (especially, a voltage difference between the first level input terminal V1 and the data write terminal Vdata). This stage can be regarded as a gating stage. When no ON signal is inputted into the scan terminal Vscan any longer, the input terminal of the gating circuit 20 is disconnected from the output terminal thereof. In this case, since the energy storage circuit 40 has stored energy determined by voltages at the first level input terminal V1 and the data write terminal Vdata, the voltage at the control terminal of the drive circuit 30 will remain the same as that in the gating stage. In this way, the inorganic EL device 10 can be continuously provided with a same drive current as that in the gating phase, such that it can continue to emit light. This stage can be regarded as a non-gating stage.

In light of the above discussion, when a frame of image is displayed on a display device using the pixel circuit, the ON signal will be provided to the scan terminal Vscan of the pixel circuit line by line. In this case, if the ON signal is provided to the scan terminal Vscan of the pixel circuit in the n^{th} row, the corresponding inorganic EL device 10 will emit light. When the ON signal is inputted into the scan terminal Vscan of the pixel circuit after the n^{th} row, the inorganic EL device 10 of the pixel circuit in the n^{th} row will continue to emit light, due to the presence of the energy storage circuit. In this way, on the premise that advantages such as high color gamut, high transmittance, and long lifetime of the inorganic EL display device are ensured, the display effect of the inorganic EL display device can be further improved with higher entire brightness and more consecutive pictures. Besides, even if the display device has a larger size, a good display effect can be achieved by arrangement of the pixel circuit. As a result, the inorganic EL device 10 can be applied in a large-sized display device, and hence applied more widely.

In a specific embodiment, the first level input terminal V1 is a high level input terminal, and the second level input terminal V2 is a low level input terminal, e.g., a ground terminal Correspondingly, the first pole of the inorganic EL device 10 is a positive pole and the second pole thereof is a negative pole.

Specifically, as shown in FIG. 2, the gating circuit 20 comprises a gating transistor T1. A gate of the gating transistor T1 is a control terminal of the gating circuit 20, a first pole thereof is an input terminal of the gating circuit 20, and a second pole thereof is an output terminal of the gating circuit 20. In other words, the gate of the gating transistor T1 is connected with the scan terminal Vscan, the first pole of the gating transistor T1 is connected with the data write terminal Vdata, and the second pole of the gating transistor T1 is connected with the control terminal of the drive circuit 30.

In a further specific embodiment, the drive circuit 30 comprises a drive transistor T2. In this case, the gate of the drive transistor T2 is a control terminal of the drive circuit 30, a first pole thereof is an input terminal of the drive circuit 30, and a second pole thereof is an output terminal of the drive circuit 30. Specifically, the gate of the drive transistor T2 is connected with the second pole of the gating transistor T1, the first pole thereof is connected with the first level input terminal V1, and the second pole thereof is connected with the inorganic EL device 10.

In a further optional embodiment, the energy storage circuit 40 comprises a capacitor Cs. In this case, a first terminal of the capacitor Cs is the first terminal of the energy storage circuit 40, and a second terminal thereof is the second terminal of the energy storage circuit 40.

In an embodiment of the present disclosure, the gating transistor T1 and the drive transistor T2 are both N-type thin film transistors. Correspondingly, the ON signal is a high level signal that switches on the N-type thin film transistors, and the OFF signal is a low level signal that switches off the N-type thin film transistors. Obviously, the gating transistor T1 and the drive transistor T2 can also be both P-type thin film transistors. In this case, the ON signal is a low level signal.

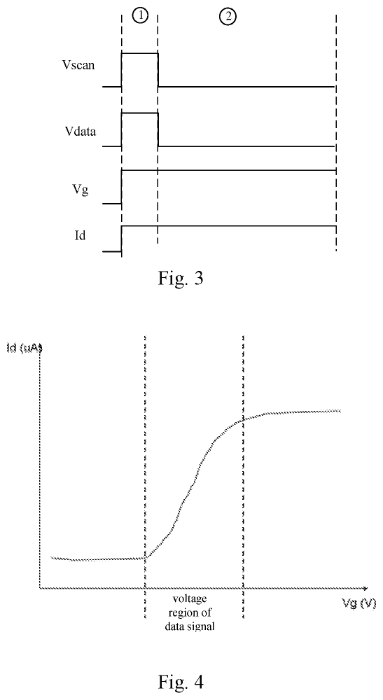

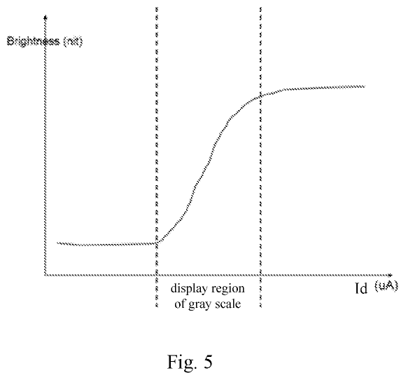

When the ON signal is inputted into the scan terminal Vscan (i.e., the gating stage\textcircled{1} in FIG. 3), the gating transistor T1 is switched on and operates in a linear region. In this case, the data signal at the data write terminal Vdata is written into the gate of the drive transistor T2 via the gating transistor T1, and the drive transistor T2 provides to the inorganic EL device 10 a drive current (i.e., a drain current Id of the drive transistor T2). At the same time, the capacitor Cs stores energy by means of the voltage over the two ends. During this stage, when the voltage of the data signal provided by the data write terminal Vdata reaches a certain value, the drive transistor T2 will operate in a saturated region, and a drive current Id generated thereby will be positively proportional to a gate voltage Vg of the drive transistor T2. In this way, the inorganic EL device 10 will be controlled to generate a corresponding brightness. FIG. 4 shows a graph reflecting the relationship between the drive current Id and the gate voltage Vg of the drive transistor T2 (i.e., the voltage at the data write terminal Vdata), and FIG. 5 shows a graph reflecting the relationship between the brightness of the inorganic EL device 10 and the drive current Id. In FIG. 4, the portion between two dashed lines is a voltage region of data signal. Within this range, the higher the voltage of the data signal provided by the data write terminal Vdata is, the higher the brightness of the inorganic EL device 10 will be. Thus, the brightness of the inorganic EL device 10 can be adjusted by the data signal. When the OFF signal is provided to the scan terminal Vscan (i.e., the non-gating stage\textcircled{2} in FIG. 3), the gating transistor T1 is switched off In this case, due to the energy stored in the capacitor Cs, the voltage over the two ends of the capacitor Cs will remain the same as in the gating stage. As a result, the gate voltage of the drive transistor T2 remains the same as in the gating stage, and the inorganic EL device 10 can continue to emit light with a same brightness as that in the gating stage.

According to a further aspect of the present disclosure, a driving method for the above pixel circuit is provided. The driving method comprises steps as follows.

In a gating stage, an ON signal is provided to the scan terminal Vscan of the pixel circuit and a data signal is provided to the data write terminal Vdata, such that the gating circuit 20 is switched on. In this case, the data signal is written into the control terminal of the drive circuit 30, the drive circuit 30 provides a corresponding drive current to the inorganic EL device 10 according to the data signal, and the energy storage circuit 40 stores energy by means of the voltage over the two ends thereof.

In a non-gating stage following the gating stage, an OFF signal is provided to the scan terminal Vscan of the pixel circuit, such that the gating circuit 20 is switched off In this case, the voltage over the two ends of the storage circuit 40 will remain unchanged, such that the voltage at the control terminal of the drive circuit 30 remains the same as in the gating stage, i.e., still equal to the voltage of the data signal. Therefore, in the non-gating stage, the drive circuit 30 continues to provide to the inorganic EL device 10 a same drive current as that in the gating stage.

As mentioned above, the gating circuit 20 comprises a gating transistor T1, the drive circuit 30 comprises a drive transistor T2, and the energy storage circuit 40 comprises a capacitor Cs. In this case, during the gating stage, the gating transistor T1 and the drive transistor T2 are both switched on, the drive transistor T2 generates a corresponding drain current according to the gate voltage, and the capacitor Cs stores energy by means of a voltage difference between the two ends thereof. In the non-gating stage, the gating transistor T1 is switched off In this case, due to the energy stored by the capacitor Cs, the voltage between the two ends thereof will remain unchanged. Therefore, the gate voltage of the drive transistor T2 remains unchanged, and the drive circuit 30 continues to provide to the inorganic EL device 10 a same drive current as that in the gating stage. When the gating transistor T1 and the drive transistor T2 are both N-type thin film transistors, in the gating stage, the ON signal provided to the scan terminal Vscan is a high level signal.

According to yet another aspect of the present disclosure, an array substrate is provided. The array substrate comprises a plurality of gate lines and a plurality of data lines, wherein the plurality of gate lines and the plurality of data lines divide the array substrate into a plurality of pixel units. Specifically, each pixel unit is provided with the above pixel circuit, wherein the scan terminal of the pixel circuit is connected with a corresponding gate line, and the data write terminal of the pixel circuit is connected with a corresponding data line. Obviously, the array substrate may further comprises a first level signal line and a second level signal line. In this case, the first level signal line is used for providing a first level signal to the first level input terminal of each pixel circuit, and the second level signal line is used for providing a second level signal to the second level input terminal of each pixel circuit.

According to still another aspect of the present disclosure, a display device is provided, comprising the above array substrate.

The display device further comprises a gate drive circuit and a source drive circuit. Specifically, the gate drive circuit can be arranged on the array substrate and configured for providing an ON signal to a plurality of gate lines line by line. While, the source drive circuit is configured for providing a corresponding data signal to a plurality of data lines respectively. When the display device displays a frame of image, the gate drive circuit provides the ON signal line by line to the plurality of gate lines. In this case, if the ON signal is provided to the n^{th} gate line, the source drive circuit will provide to each data line a data signal corresponding to a gray scale of each pixel unit in the n^{th} row. Then, the pixel circuit in the n^{th} row is in a gating stage, and the corresponding inorganic EL device will emit light with a corresponding brightness. Furthermore, when the ON signal is provided to the pixel circuit in the (n+1)^{th} row, the source drive circuit will provide to each data line a data signal corresponding to a gray scale of each pixel unit in the (n+1)^{th} row. Then, the pixel circuit in the (n+1)^{th} row is in a gating stage, such that each inorganic EL device in the (n+1)^{th} row will emit light with a corresponding brightness. At the same time, the pixel circuit in the n^{th} row is in a non-gating stage. However, the drive circuit of the pixel circuit still provides in the non-gating stage a same drive current as that in the gating stage to the inorganic EL device. In this case, when each inorganic EL device in the (n+1)^{th} row emits light, each inorganic EL device in the n^{th} row still maintains the original brightness, until the full picture is displayed.

The above description is directed to the pixel circuit and the driving method thereof, the corresponding array substrate and display device, as proposed in the present disclosure. It can be seen that as compared with an existing inorganic EL display device, in the pixel circuit provided by the embodiments of the present disclosure, the inorganic EL device emits light when an ON signal is inputted into the scan terminal in a gating stage, and after the gating stage, it still can emit light, even if an OFF signal is inputted into the scan terminal Therefore, when gate lines in the inorganic EL display device using the pixel circuit is scanned line by line so as to display images, pixel units in the previous row can still maintain the original light-emitting state even when the next row is scanned. In this way, on the premise that advantages such as high color gamut, high transmittance, and long lifetime of the inorganic EL display device are ensured, the display effect of the inorganic EL display device can be further improved with higher entire brightness and more consecutive pictures. Besides, even if the display device has a larger size, a good display effect can be achieved by arrangement of the pixel circuit. As a result, the inorganic EL device can be applied in a large-sized display device, and hence applied more widely.

It can be understood that the above embodiments are only exemplary embodiments adopted for illustrating the principle of the present disclosure, but the present disclosure is not limited thereto. For a person having ordinary skills in the art, various variations and improvements can be made without deviating from the spirit and essence of the present disclosure, and these variations and improvements are also considered to fall within the protection scope of the present disclosure.

1. A pixel circuit, comprising: an inorganic electroluminescent device, a scan terminal, a data write terminal, a first level input terminal, a second level input terminal, a gating circuit, a drive circuit, and an energy storage circuit, wherein
a control terminal of the gating circuit is connected with the scan terminal, an input terminal thereof is connected with the data write terminal, and an output terminal thereof is connected with a control terminal of the drive circuit, wherein the gating circuit is configured to be switched on when an ON signal is inputted into the scan terminal and switched off when an OFF signal is inputted into the scan terminal;
an input terminal of the drive circuit is connected with the first level input terminal, and an output terminal thereof is connected with a first pole of the inorganic electroluminescent device, wherein the drive circuit is configured to provide a corresponding drive current to the inorganic electroluminescent device according to a data signal received at the control terminal thereof;
a second pole of the inorganic electroluminescent device is connected with the second level input terminal; and
a first terminal of the energy storage circuit is connected with the first level input terminal, and a second terminal thereof is connected with the control terminal of the drive circuit, wherein the energy storage circuit is configured to store energy when the ON signal is inputted into the scan terminal and release the stored energy when the OFF signal is inputted into the scan terminal.

2. The pixel circuit according to claim 1, wherein
the gating circuit comprises a gating transistor, wherein a gate of the gating transistor is the control terminal of the gating circuit, a first pole thereof is the input terminal of the gating circuit, and a second pole thereof is the output terminal of the gating circuit.

3. The pixel circuit according to claim 2, wherein
the gating transistor is an N-type thin film transistor,
the gating circuit is configured to be switched on when a high level signal is inputted into the scan terminal, and
the energy storage circuit is configured to store energy when the high level signal is inputted into the scan terminal.

4. The pixel circuit according to claim 1, wherein
the drive circuit comprises a drive transistor, wherein a gate of the drive transistor is the control terminal of the drive circuit, a first pole thereof is the input terminal of the drive circuit, and a second pole thereof is the output terminal of the drive circuit.

5. The pixel circuit according to claim 4, wherein the drive transistor is an N-type thin film transistor.

6. The pixel circuit according to claim 1, wherein
the energy storage circuit comprises a capacitor, wherein a first terminal of the capacitor is the first terminal of the energy storage circuit, and a second terminal thereof is the second terminal of the energy storage circuit.

7. The pixel circuit according to claim 1, wherein
the first level input terminal is a high level input terminal, and
the second level input terminal is a low level input terminal.

8. A driving method for the pixel circuit according to claim 1, comprising:
in a gating stage, providing an ON signal to the scan terminal of the pixel circuit and providing a data signal to the data write terminal, such that the gating circuit is switched on, wherein the data signal is written into the control terminal of the drive circuit, the drive circuit provides a corresponding drive current to the inorganic electroluminescent device according to the data signal, and the energy storage circuit stores energy; and
in a non-gating stage following the gating stage, providing an OFF signal to the scan terminal of the pixel circuit, such that the gating circuit is switched off, wherein the energy storage circuit continues to provide a corresponding drive current to the inorganic electroluminescent device by releasing the stored energy.

9. An array substrate, comprising: a plurality of gate lines and a plurality of data lines, wherein
the plurality of gate lines and the plurality of data lines divide the array substrate into a plurality of pixel units, and
each pixel unit is provided with the pixel circuit according to claim 1, wherein the scan terminal of the pixel circuit is connected with a corresponding gate line, and the data write terminal of the pixel circuit is connected with a corresponding data line.

10. A display device, comprising the array substrate according to claim 9.

11. The array substrate according to claim 9, wherein
the gating circuit comprises a gating transistor, wherein a gate of the gating transistor is the control terminal of the gating circuit, a first pole thereof is the input terminal of the gating circuit, and a second pole thereof is the output terminal of the gating circuit.

12. The array substrate according to claim 11, wherein
the gating transistor is an N-type thin film transistor,
the gating circuit is configured to be switched on when a high level signal is inputted into the scan terminal, and
the energy storage circuit is configured to store energy when the high level signal is inputted into the scan terminal.

13. The array substrate according to claim 9, wherein
the drive circuit comprises a drive transistor, wherein a gate of the drive transistor is the control terminal of the drive circuit, a first pole thereof is the input terminal of the drive circuit, and a second pole thereof is the output terminal of the drive circuit.

14. The array substrate according to claim 13, wherein the drive transistor is an N-type thin film transistor.

15. The array substrate according to claim 9, wherein
the energy storage circuit comprises a capacitor, wherein a first terminal of the capacitor is the first terminal of the energy storage circuit, and a second terminal thereof is the second terminal of the energy storage circuit.

16. The array substrate according to claim 9, wherein
the first level input terminal is a high level input terminal, and
the second level input terminal is a low level input terminal.

17. The driving method according to claim 8, wherein
the gating circuit comprises a gating transistor, wherein a gate of the gating transistor is the control terminal of the gating circuit, a first pole thereof is the input terminal of the gating circuit, and a second pole thereof is the output terminal of the gating circuit.

18. The driving method according to claim 8, wherein
the drive circuit comprises a drive transistor, wherein a gate of the drive transistor is the control terminal of the drive circuit, a first pole thereof is the input terminal of the drive circuit, and a second pole thereof is the output terminal of the drive circuit.

19. The driving method according to claim 8, wherein
the energy storage circuit comprises a capacitor, wherein a first terminal of the capacitor is the first terminal of the energy storage circuit, and a second terminal thereof is the second terminal of the energy storage circuit.

20. The driving method according to claim 8, wherein
the first level input terminal is a high level input terminal, and
the second level input terminal is a low level input terminal.
